(19) United States
(12) Patent Application Publication
(10) Pub. No.: US 2018/0036925 A1
(43) Pub. Date: Feb. 8, 2018

(54) Constrained Motion with Reformable Guide Member

(71) Applicant: Edward Korn, Fitchburg, WI (US)

(72) Inventor: Edward Korn, Fitchburg, WI (US)

(21) Appl. No.: 15/359,557

(22) Filed: Nov. 22, 2016

Related U.S. Application Data
(60) Provisional application No. 62/371,158, filed on Aug. 4, 2016.

(51) Int. Cl. B29C 45/00; B29C 45/14

(52) U.S. Cl. CPC B29C 45/0017; B29C 45/14336; B29K 2023/0683

(57) ABSTRACT

An improved design and method is disclosed for constructing a sliding joint that constrains motion along or about one or more axes or directions and allows motion with low friction along or about a different axes or direction. The design simplifies the fabrication and assembly of sliding joints requiring accurate sliding alignment with minimal clearance between sliding members, such as milling machine bases, saddles, tables and columns. The design also enables driving means, such as those commonly found in machine tools using a leadscrew and nut, to be fabricated with essentially zero backlash at a very low cost. Finally, the design enables bearing surfaces to be reformed after they have worn without the need for disassembly of components. This allows for complete recovery of the original precisely guided configuration without the need to disassemble a machine. The simplicity and low cost of the method will be especially advantageous in the manufacture of machine tools intended for education and maker markets.

### BACKGROUND OF THE INVENTION

### Field of the Invention

The present invention relates generally to the need in many types of machines and devices to constrain motion along or about certain axes or directions while facilitating low friction guided motion along or about other axes or directions. The invention enables a new method for the construction of sliding joints which are able to accurately guide motion along a desired axis or direction while constraining motion and providing strength and support along other axes or directions. Due to its simplicity and low cost the invention relates to many types of machines and devices including milling machines, vices, and lathes.

### Description of the Prior Art

There is a well-known need in the machine art for accurately guided motion. There are often significant forces involved in guiding or driving machine members so the means of constraining and guiding motion must be strong enough and rigid enough to withstand these forces.

In machine tools, for example in milling machines, ways are used to constrain motion in two directions and accurately guide and allow motion in a third direction. For example, the ways on the column of a vertical milling machine allow guided motion in the “z” direction (vertical movement) and constrain motion in the “x” and “y” directions (horizontal movement). The ways also constrain rotation about all three axes (x, y, and z). Referring to degrees of freedom (DOF) there are 6 possible DOF: 3 linear along the x, y and z axes and 3 rotational about the x, y and z axes. The ways on the column of a vertical milling machine constrain 5 DOF and leave 1 DOF unconstrained. This results in accurately guided motion on the unconstrained DOF, which is accurately guided linear movement along the z axis in this case.

In yet another example a rotating leadscrew sliding in a nut is used to drive a machine table along one axis. In this application it is extremely important that there is as little backlash, or clearance, between the mating components as possible to ensure accurate positioning. Internally threaded plastic nuts or more complicated ball nuts in combination with a leadscrew are often used in the prior art. Achieving accurate alignment while minimizing backlash and providing a low friction joint has previously required extremely accurately formed parts which make it difficult and costly.

There therefore exists a need for a low-cost construction that provides strength, stiffness, and accurate alignment of sliding and/or rotating parts in some directions while still allowing movement with low friction in a different direction. Various aspects of this need have been recognized in the prior art.

The prior art includes methods for providing threaded apertures in devices made by a molding process. U.S. Pat. No. 3,528,637 (Bedford) describes a method for molding internal threads in an aperture for receiving a threaded member. The method described in Bedford requires a die and core set which are used in a molding machine. Once the threaded part has been produced in a molding machine it is removed and then subsequently assembled into a device.

U.S. Pat. No. 4,079,475 (Thompson) describes a method of casting or molding a single internal thread in a product using an external mold and core pins. U.S. Pat. No. 4,554,962 (Wright) describes yet another method of molding or casting an internally screw threaded article using flat core members within the mold cavity. Here again a complicated molding machine with molds and core pins is required to produce internally threaded apertures.

The above methods disclosed in the prior art for forming internal threads from molded or cast parts all require molds, core pieces and the associated machinery to manipulate mold pieces and inject material. In order to achieve the close clearances between components necessary for accurately guided motion precise manufacturing tolerances are required on molds, core pieces and the associated machinery.

The need to provide accurate alignment between a driving member such as a leadscrew and a driven member such as a nut or ball nut is also well known in the prior art. U.S. Pat. No. 5,142,929 (Simpson) describes a ball nut with ball bearings used in conjunction with a leadscrew to provide accurate alignment and reduce backlash between the ball nut and lead screw. Ball nuts are complicated and expensive devices which are difficult to fabricate and assemble.

Another common need in machines and other devices is the need for accurate sliding linear alignment. U.S. Pat. No. 5,330,272 (Stoll) describes a linear drive using a longitudinal slot and a guide part which is guided for motion along the longitudinal slot. Again precise manufacturing tolerances are required on both the slot and guide part in order to accurately guide motion.

Yet another common need in machines and other devices is the need for accurate rotating alignment. U.S. Pat. No. 4,967,465 (Frank) describes a method of assembling a rotor retaining ring system to provide rotating alignment between the body and rotating member of an electric motor. The retaining rings require precise tolerances and require disassembly for replacement.

The need for accurate alignment in vices is also known in the art. U.S. Pat. No. 4,043,547 (Glomb) describes a machine vice with features for accurate aligning purposes. The vice components require precision machining and are expensive to manufacture with high accuracy.

The above methods disclosed in the prior art describe various methods that have been used to produce components which allow accurate alignment and positioning combined with guided motion.

Attaching polymers to threaded fasteners is also known in the art for the restriction of rotation to provide a locking torque. U.S. Pat. No. 3,784,435 (Bagheri) describes a method of forming a plastic patch on a screw fastener used to lock the fastener in place. This method is not applicable to forming internal threads which allow movement between a driving device such as a leadscrew and nut.

U.S. Pat. No. 4,706,352 (Furmanek) describes forming seats used to support bearing surfaces for slidable alignment by filling a pocket with a low friction epoxy material which hardens in place. The seats made of low friction epoxy material described by Furmanek are not bearing surfaces, but rather seats supporting bearing surfaces. Further, the method disclosed by Furmanek requires removable tooling blocks to form the bearing seats, and the seats are not formed by extrusion, simply by pouring a hardenable fluid into a cavity. Finally, in Furmanek as bearing surfaces wear they will need to be removed and replaced.

U.S. Pat. No. 5,592,728 (Susnjara) discloses a method of forming a guideway using a hardenable structural polymer. In Susnjara removable fixturing or tooling is required to position components prior to using the hardenable structural polymer and barriers are required to contain the hardenable structural polymer while it hardens. Once the hardenable structural polymer in Susnjara hardens it cannot be reformed in place. When the bearing surfaces in Susnjara are worn and need to be replaced the old structural polymer must first be removed. Then fixturing and tooling as well as barriers are required to re-create a new bearing surface.

U.S. Pat. No. 3,115,696 (Evans) discloses a method of manufacturing a slide unit that includes bonding a solid pad of thermoplastic material to one guide surface, heating one of the slide components, assembling the slide, and then cooling the slide components. Evans requires bonding of the thermoplastic material to one of the guide surfaces. Evans does not disclose completely liquefying the thermoplastic material so that it conforms to the shape of the joint between sliding components. Evans also does not disclose reforming of the thermoplastic material after the initial melting operation to recover from wear. There is no extrusion or even injection of liquid material disclosed by Evans.

### SUMMARY OF THE INVENTION

In view of the foregoing disadvantages inherent in the design, manufacture, and assembly of sliding joints with guided motion in the prior art the present invention provides an improved design and method to simply and inexpensively build sliding joints with minimal clearance between the mating parts. The simplicity and low-cost of the design will be advantageous for many machines.

For many types of devices and machinery one part of the machine must be accurately positioned while it is moved through precise motion increments. The sliding motion must be accomplished in a smooth and efficient manner with a minimum amount of friction. In the past to provide the necessary stability and efficiency of operation precise machining operations were performed to form mating surfaces with minimal clearances between the sliding member and support members. These machining operations are quite expensive and time-consuming and are also subject to error.

In addition, in order make to maintain precise alignment the sliding bearing components were required to be periodically removed and replaced due to wear. This is expensive and time-consuming because it requires various portions of the machine or device to be disassembled. On some devices disassembly and replacement of bearing components is sufficiently expensive that the devices are discarded and not rebuilt once the bearing surfaces have worn.

In addition to requiring the costly purchase of new machines or devices discarding rather than repairing machines consumes energy and material resources. That is to say it is less sustainable to discard machines than to design them so they can be conveniently repaired and reconditioned.

Further, smooth and efficient operation of sliding members often requires low friction drag combined with vibration damping at the sliding connection. Materials with optimal low friction and vibration damping properties often wear faster than other materials so their use in many devices prior to the present invention was not economically feasible.

The general purpose of the present invention, which will be described subsequently in greater detail, is to provide a new and improved construction for sliding joints that provide guided motion which has all of the advantages of the prior art and none of the disadvantages.

To achieve this purpose the present invention essentially comprises a design and method of forming precise bearing surfaces in place that eliminates the need for expensive machining of sliding components and also provides for the ability to conveniently and inexpensively reform sliding bearing components in place without the need to disassemble machine components. The design can use materials that reduce friction and damp vibration in a machine.

The invention is a design and method of producing sliding components which include cavities into which a hardenable fluid is inserted after the sliding components have been assembled. The method of making a sliding joint includes the steps of fabricating opposing sliding surfaces with cavities between them and then introducing a hardenable fluid into these cavities. When the hardenable fluid hardens it forms bearing surfaces that conform precisely with essentially zero clearance between the hardened fluid and the opposing slide members. The design of the opposing sliding surfaces includes features that, when they are filled with the hardened fluid, serve to ensure the hardened fluid is properly located and supported.

The method also includes the ability to use hardenable fluids that can be re-liquefied in place, for example by melting, and allowed to re-harden. When used in this embodiment the method allows worn bearing surfaces to be completely reformed in place without the need for disassembly of the machine or device.

The invention enables many sliding elements of a machine tool or other device to be constructed of components with relatively relaxed tolerances and then assembled into a final sliding construction with minimal clearances between components. This allows for accurate positioning and support and minimal friction in the desired direction of travel. Many different constructions which require accurately guided sliding motion can be fabricated using the invention.

There has thus been broadly outlined the more important features of the invention in order that the detailed description thereof that follows may be better understood, and in order that the present contribution to the art may be better appreciated. There are, of course, additional features of the invention that will be described hereinafter.

In this respect, before explaining the invention in detail, it is to be understood that the invention is not limited in its application to the details of construction and to the arrangements of the components set forth in the following description and illustrated in the drawings. The invention is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the design of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved design and method for producing guided sliding surfaces which enables machines and devices to be built with precise tolerances and lower manufacturing and assembly costs which has all of the advantages of prior art machines and none of the disadvantages.

It is another object of the present invention to provide sliding connections using a low friction material which are accurately located and have a long service life by virtue of the ability to easily reform the bearing material in place without the need for disassembly of a device.

These objects, together with other objects of the invention, along with the various features of novelty which characterize the invention, are pointed out with particularity in the following detailed description. For a better understanding of the invention, its operating advantages, and specific objects attained by its uses, reference should be had to the accompanying drawings and descriptive material in which there is illustrated a preferred embodiment of the invention.

Further, the purpose of the abstract of this invention is to enable the US Patent and Trademark Office, the public generally, and especially scientists, engineers and practitioners in the art not familiar with patent or legal terms or phraseology to determine quickly from a cursory inspection the nature and essence of the technical disclosure of the application. The abstract is not intended to be limiting as to the scope of the invention in any way.

### BRIEF DESCRIPTION OF THE DRAWINGS

The invention will be better understood when consideration is given to the following detailed description of the invention. Such description makes reference to the following drawings:

FIG. 1A is a side view of a leadscrew as utilized in the present invention.

FIG. 1B is an end view of a leadscrew as utilized in the present invention.

FIG. 2A is a side view of a rod with a radial groove as utilized in the present invention.

FIG. 2B is an end view of a rod with a radial groove as utilized in the present invention.

FIG. 3A is a side view of a rod with a groove running along its length as utilized in the present invention.

FIG. 3B is an end view of a rod with a groove running along its length as utilized in the present invention.

FIG. 4A is a side view of a cylindrical rod as utilized in the present invention.

FIG. 4B is an end view of a cylindrical rod as utilized in the present invention.

FIG. 5 is an exploded front view of an assembly consisting of a rectangular nut, a slug of reformable material, and a cap.

FIG. 6 is a top view the rectangular nut shown in FIG. 5.

FIG. 7 is a top view of the cap shown in FIG. 5.

FIG. 8A is a top view of an assembly of the rectangular nut shown in FIG. 5 with the leadscrew shown in FIG. 1A inserted through the nut with some hidden lines removed for clarity.

FIG. 8B is a top view of an assembly of the rectangular nut shown in FIG. 5 with the leadscrew shown in FIG. 1A inserted through the nut and the cap shown in FIG. 7 with some hidden lines removed for clarity.

FIG. 9 is a cross-section view of the assembly shown in FIG. 8B at section A-A showing reformable bearing material and compression means.

FIG. 10 is an exploded front view of an assembly showing a rectangular nut, a slug of reformable material, and a cap as shown in FIG. 5 and also showing a compression means, a plate, and a heating means.

FIG. 11 is a top view showing two nested ways with hidden lines removed.

FIG. 12 is a section view along section A-A in FIG. 12 showing two nested ways in the nested position.

FIG. 13 is a section view along section A-A in FIG. 12 showing two nested ways in the nested position and showing reformable bearing material and compression means.

FIG. 14 is a top view of an assembly with a leadscrew and rectangular nut configured to drive a slide utilizing the present invention.

FIG. 15 is a front view of the assembly shown in FIG. 14.

FIG. 16 is a top view of a vise utilizing the present invention.

FIG. 17 is a front view of the vise shown in FIG. 16.

FIG. 18 is a side view of the vise shown in FIG. 16.

FIG. 19 is a bottom view of the vise jaws shown in FIG. 16 utilizing the present invention.

### DETAILED DESCRIPTION AND BEST MODE OF IMPLEMENTATION

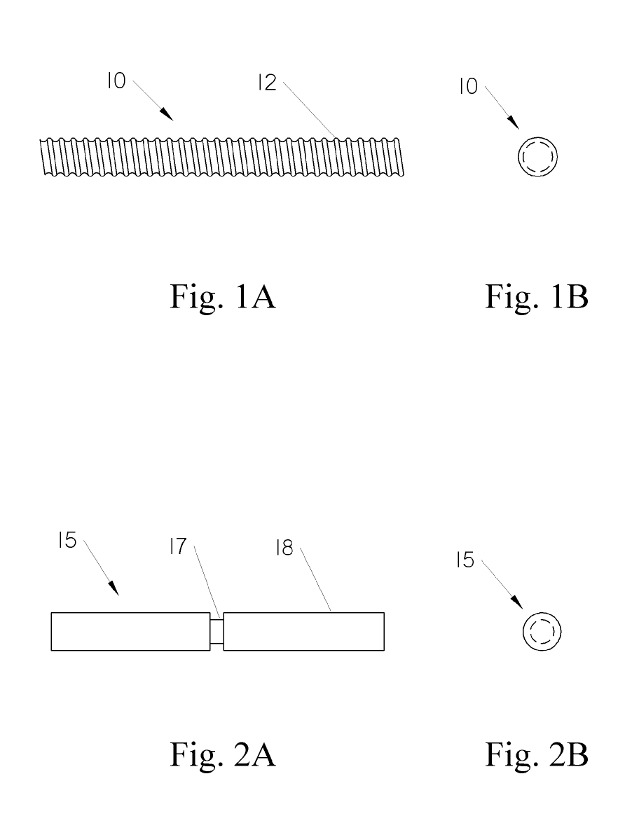

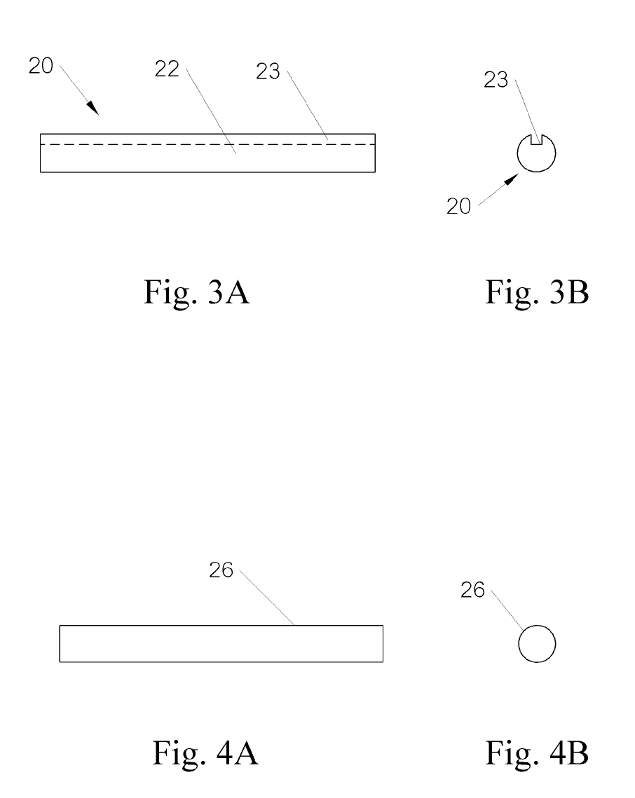

With reference now to the drawings, wherein like numerals designate like parts, FIG. 1A shows a side view of a leadscrew 10 with threads 12. FIG. 1B shows an end view of leadscrew 10. FIG. 2A shows a side view of shaft 15 with an annular groove 17 formed in body 18. FIG. 2B shows an end view of shaft 15. FIG.3A shows a side view of shaft 20 with a longitudinal groove 23 in body 22. FIG. 3B shows an end view of shaft 20. FIG. 4A shows a side view of shaft 26 and FIG. 4B shows an end view of shaft 26.

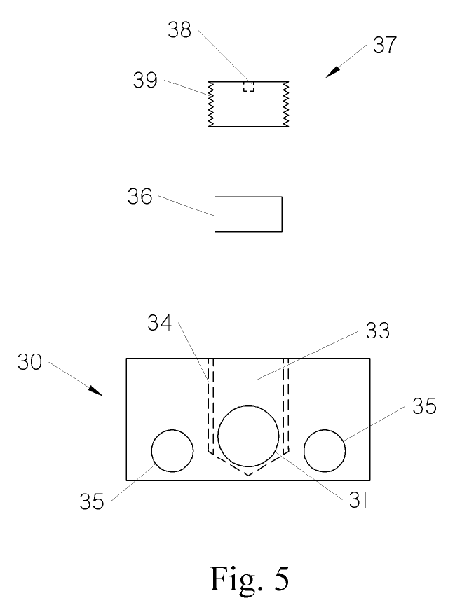

FIG. 5 shows a side view of rectangular nut 30 with a clearance hole 31 suitable for receiving any of the shafts shown in FIGS. 1-4. Nut 30 includes a cavity 33 in its top surface for receiving a slug of reformable material 36 and two mounting holes 35 for securing the nut to a machine tool member. Cavity 33 includes engaging means 34 along its edges. Cap 37 is configured with engaging means 39 and driving means 38.

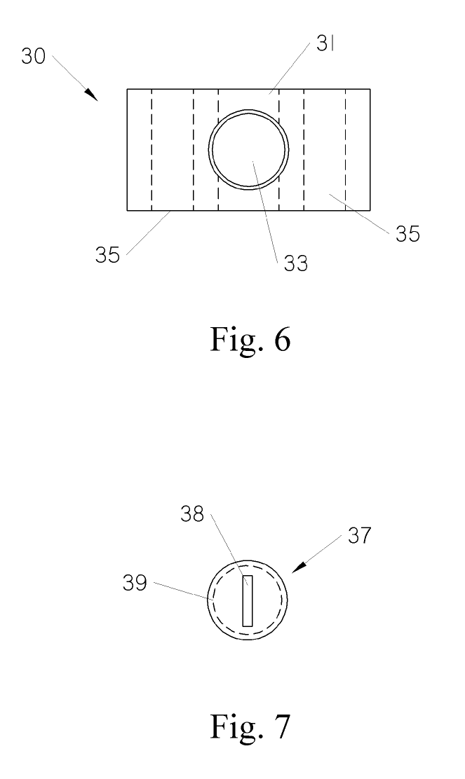

FIG. 6 shows a top view of rectangular nut 30 showing cavity 33 and indicating the locations of clearance hole 31 and mounting holes 35. FIG. 7 shows a top view of cap 37 with driving means 38 and engaging means 39.

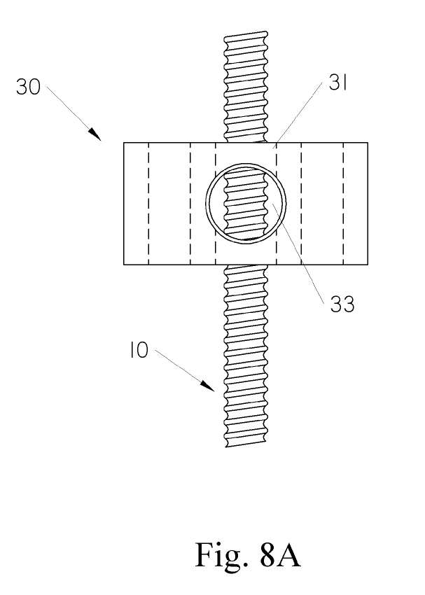

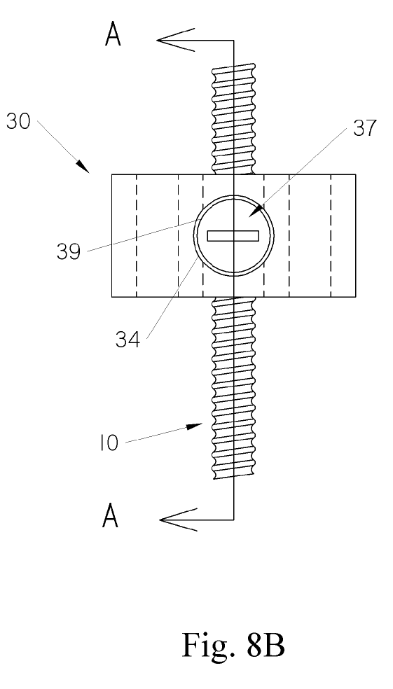

FIG. 8A shows a top view of leadscrew 10 inserted in clearance hole 31 in rectangular nut 30. Leadscrew 10 is visible in cavity 33. Hidden lines for the leadscrew 10 have been removed for clarity.

FIG. 8B shows a top view of leadscrew 10 inserted in clearance hole 31 in rectangular nut 30. Cap 37 is shown inserted in nut 30 using engaging means 34 and 39.

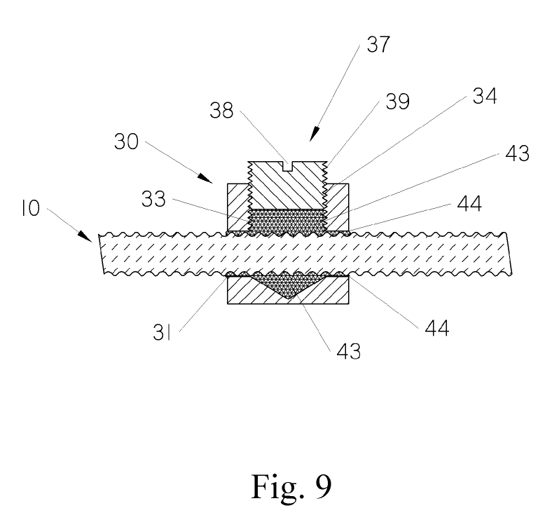

FIG. 9 shows a view along section A-A in FIG. 8B showing an assembly made using the present invention. The assembly shown in FIG. 9 is formed by inserting leadscrew 10 in rectangular nut 30 as shown in FIG. 8A. Next a slug of reformable bearing material shown as 36 in FIG. 5 is inserted in cavity 33. Cap 37 is then connected to rectangular nut 30 using engaging means 34 and 39.

A wide range of materials can be used for reformable bearing material 36. Ultrahigh molecular weight polyethylene (UHMWPE, UHMW) is used in the preferred embodiment. Other versions of polyethylene can be used and different types of plastic or other materials can be used for the bearing material. Key features of the bearing material are low sliding friction, good mechanical strength, and the ability to flow when heated and solidify when cooled.

Leadscrew 10, nut 30, and cap 37 are typically formed of metals such as steel or aluminum in preferred embodiments of the invention. They can, however, be formed of plastic or any other material provided it has sufficient strength to withstand the required forces and remains stable at temperatures that are required to melt the reformable bearing material.

In the preferred embodiment of the invention the assembly shown in FIG. 9 is then heated until reformable bearing material 36 is flowable. Driving means 38 in cap 37 is then used to move cap 37 further into nut 30 thereby extruding bearing material 36 throughout the lower portion of internal cavity 33 and between clearance hole 31 and leadscrew 10. The reformable bearing material is now indicated by 43 in FIG. 9. Reformable bearing material initially in the shape of 36 in FIG. 5 has now been formed into the shape indicated by 43 in FIG. 9.

Shoulders 44 formed by clearance hole 31 serve to support leadscrew 10 in its proper position during the extrusion process. Clearance between clearance hole 31 and nut 30 also provides a means for air to escape as the reformable bearing material is extruded into the cavities. Alternatively, the extrusion could be done in a vacuum.

Once the desired amount of reformable bearing material has been extruded the assembly shown in FIG. 9 is cooled and the bearing material 43 solidifies in place providing a slip fit with minimal clearances around leadscrew 10. This enables leadscrew 10 to drive rectangular nut 30, and any component attached to rectangular nut 30, in an extremely accurate manner with essentially no backlash.

The assembly shown in FIG. 9 thus creates a slidable joint with extremely tight tolerances, minimal friction, and essentially zero backlash suitable for driving components attached to, for example, machine tool tables, saddles or columns. It is important to note that the bearing material 43 is held in place by the shape of the cavity formed by rectangular nut 30, cap 37 and leadscrew 10. No adhesive or other fixtures are required to hold bearing material 43 in place. No removable fixtures are required to support the joint during fabrication.

By using leadscrew 10 as shown in FIG. 9 a rotating slidable joint suitable for driving components with a leadscrew is formed using the present invention. If it is desirable to constrain a shaft to only rotary motion shaft 15 as shown in FIG. 2 can be used in place of leadscrew 10. In this embodiment radial groove 17 would now be filled with extruded bearing material thus creating a joint that is rotatable with low friction, supported against linear and axial movement, and guided for rotation with extreme precision.

If it is desirable to constrain a shaft to linear motion shaft 20 as shown in FIG. 3 can be used in place of leadscrew 10. In this embodiment axial groove 23 would now be filled with extruded bearing material creating a joint that is slidable with low friction in the axial direction and supported against rotation or movement in the axial direction.

Finally, if it is desirable to locate a shaft without constraining either linear movement in an axial direction or rotation a plane shaft 26 as shown in FIG. 4 can be used in place of leadscrew 10. In this embodiment extruded bearing material surrounds shaft 10 creating a joint that precisely locates shaft 26 in clearance hole 31 but permits rotation or linear movement with low friction.

It should be noted that while round shafts have been used to indicate various embodiments of the invention the invention is not limited to shafts of round shape. Shafts with square, rectangular, or any other cross-sectional shape can be used in place of leadscrew 10 in FIG. 9 to create various types of slidable joints.

Another feature of the present invention is that in the preferred embodiment no additional tooling pieces are required to locate the sliding joint components. The sliding members themselves are designed to support each other before and during the extrusion process. This is shown in FIG. 9 by shoulders 44 which locate leadscrew 10.

Reformable bearing materials as used in the present invention will wear over time. After wear has occurred precise tolerances can be reestablished by reheating the assembly shown in FIG. 9, further tightening cap 37, which serves as a compression means, to re-extruded bearing material 43, and then re-cooling the assembly to solidify the bearing material 43. This operation can be repeated indefinitely as long as there is a sufficient supply of bearing material 43.

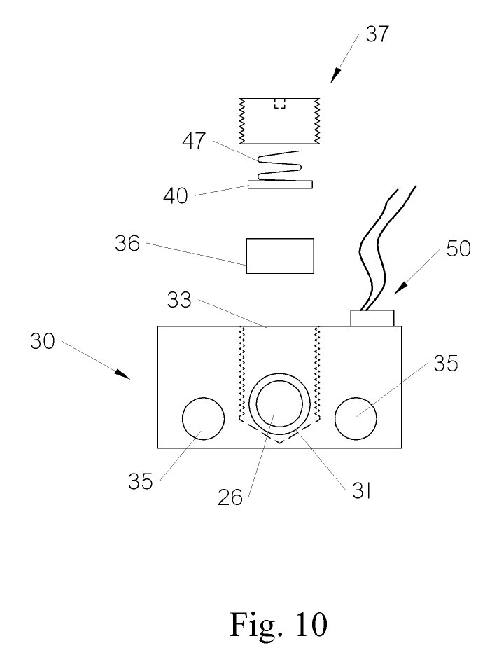

In many instances it will be desirable to be able to reform the sliding joint of the present invention without disassembling the sliding connection from a machine or device for heating. It is also desirable to be able to automatically reform the sliding joint using an electrical heating means 50 as shown in FIG. 10.

In FIG. 10 a side view of rectangular nut 30, bearing material 36 and cap 37 is shown. FIG. 10 also shows a compression means 47, which could be a spring, and a plate 40. In this embodiment when bearing material 36 is inserted in cavity 33 plate 40 is placed on top of bearing material 36 and compression means 47 is then preloaded by engaging cap 37 with nut 30. When wear has occurred and it is desirable to reform the sliding connection electrical heating means 50 can be used to heat the assembly so that bearing material 36 will reflow around a shaft 26 inserted in clearance hole 31 due to the urging of compression means 47. When heating means 50 is turned off the bearing material will re-solidify and a joint with minimal clearances and low friction will be reestablished. This same procedure can be used with any shape of shaft or cavity to reform the bearing material.

It should be noted that various configurations of electrical heating means 50 can be used to heat sliding joints of different configurations. In addition other heating means such as using inductive heaters or applying heat locally to various portions of the sliding joint as required can be used to make bearing material 36 flowable.

In addition, a spring is only one possible compression means. Other possible compression means include air pressure, hydraulic pressure, gravity and an electrical solenoid.

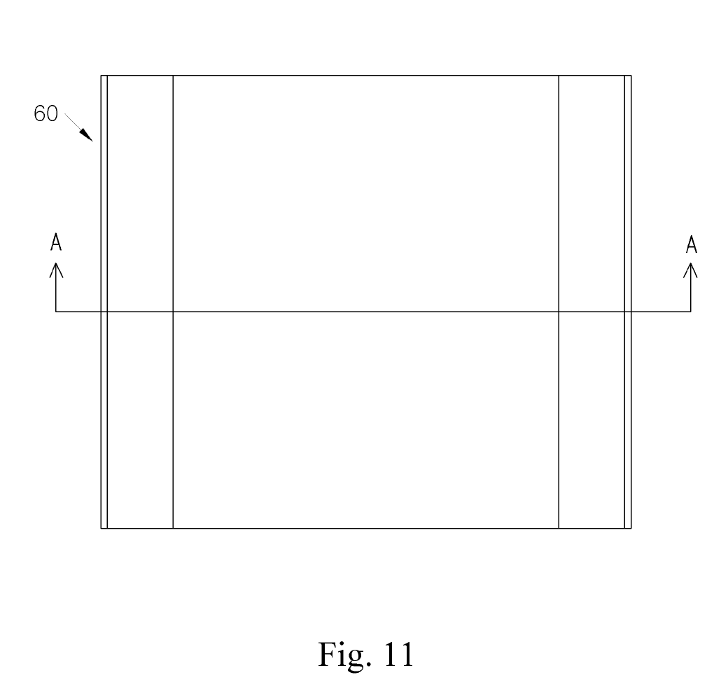

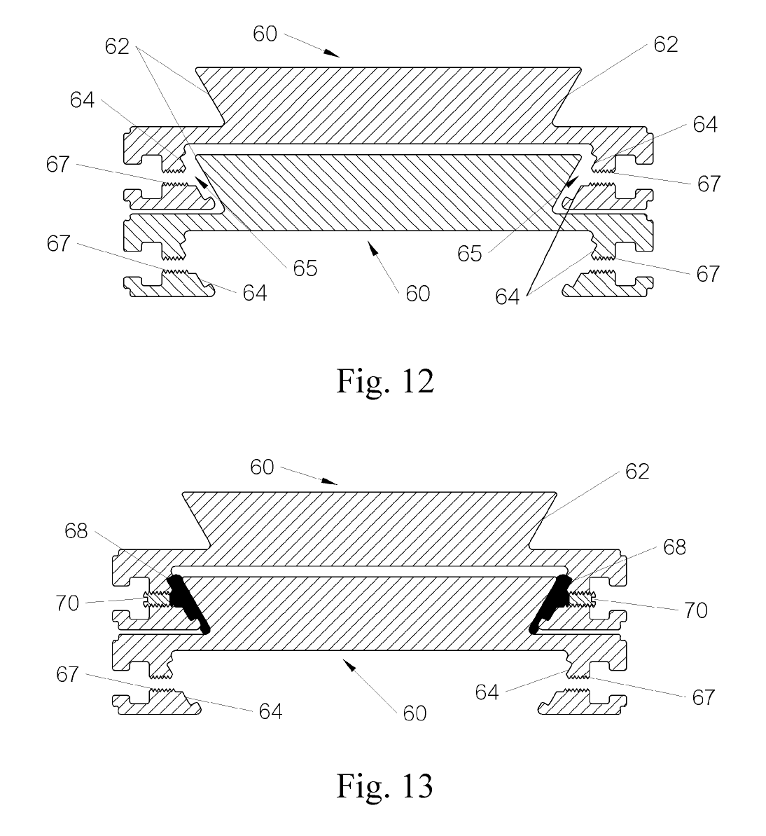

FIG. 11 shows a top view of another embodiment of the invention consisting of two nested machine tool ways 60 with hidden lines removed for clarity. FIG. 12 is a section view along section A-A in FIG. 11 showing two nested machine tool ways 60 in the nested position. The ways include a male way surface 62 and a female way surface 64. Such ways are commonly called dovetail ways or dovetail guides. Ways 60 are designed in such a way that a cavity 65 is formed when they are in the nested position. Cavity 65 is accessible by means of access hole 67.

FIG. 13 shows an assembly of the two nested ways 60 after a compression means 70 has been used to extrude bearing material 68 into the gap between the two nested ways. Compression means 70 can be a threaded cap as shown or could, for example, be a connection to a tube through which bearing material 68 can be injected. To create the assembly shown in FIG. 13 reformable bearing material 68 and nested ways 60 are heated until reformable bearing material 68 is flowable. Compression means 70 is then used to extrude bearing material 68 into the cavity formed between nested ways 60.

This creates a sliding joint with essentially zero clearance that supports and locates the upper way with respect to the lower way while allowing slidable motion in one direction only. No adhesive material or other fixture is required to support bearing material 68 in the cavity formed between nested ways 60. The shape of the cavity itself constrains the bearing material 68 in this embodiment.

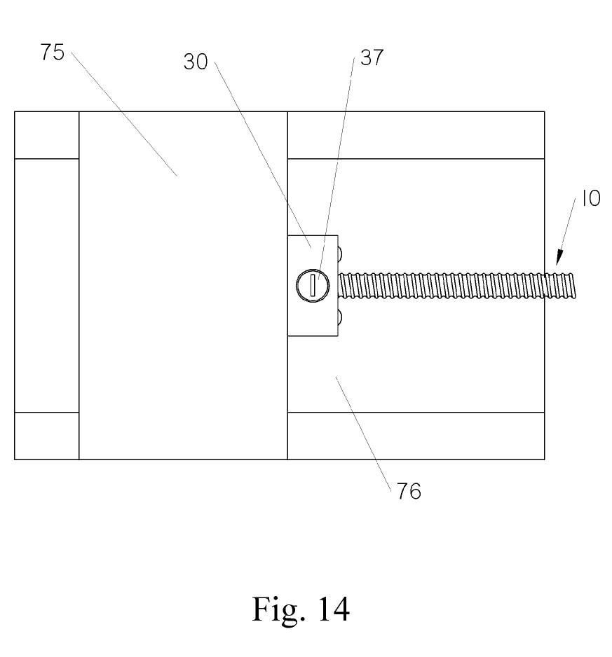

FIG. 14 is a top view of an assembly showing a leadscrew 10 configured to work with rectangular nut 30 to drive slide 75. Rectangular nut 30 and cap 37 are shown in the assembled position after the reformable bearing material has been extruded around leadscrew 10.

Rectangular nut 30 is attached to machine tool slide 75 which is supported on a bottom machine tool way 76. By rotating lead screw 10 with a driving means (not shown) force is transmitted to rectangular nut 30 and slide 75 is moved along way 76.

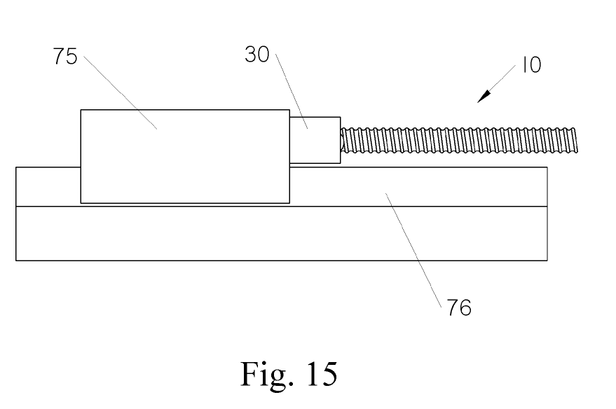

FIG. 15 is a front view of the assembly shown in FIG. 14 with nut 30 connected to machine tool slide 75 in a configuration where it can be driven by leadscrew 10 for motion along lower way 76.

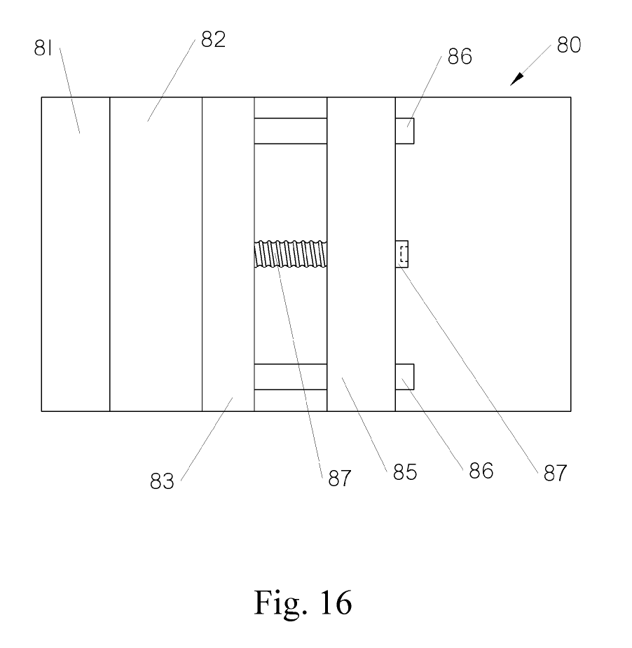

FIG. 16 is a top view of a machine vice 80 fabricated using the present invention. The vice consists of a base plate 82, a back jaw 81, a movable jaw 83 and a fixed jaw 85. Two guide pins 86 are slidably connected to fixed jaw 85 using the present invention. By rotating driving means 87 movable jaw 83 can be moved relative to fixed jaw 85. The motion of movable jaw 83 is guided by pins 86 which are slidably connected to fixed jaw 85.

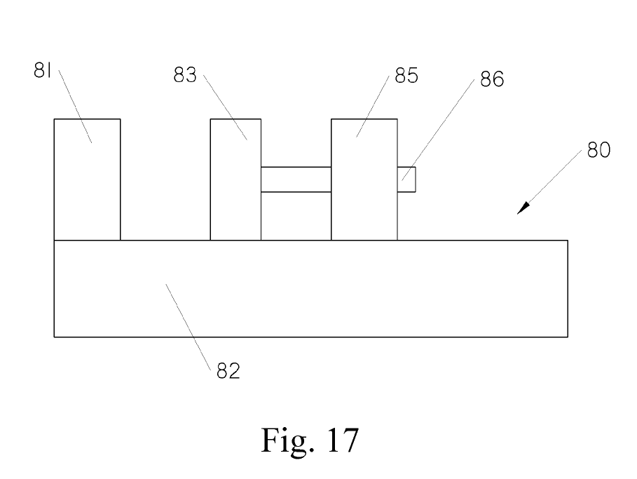

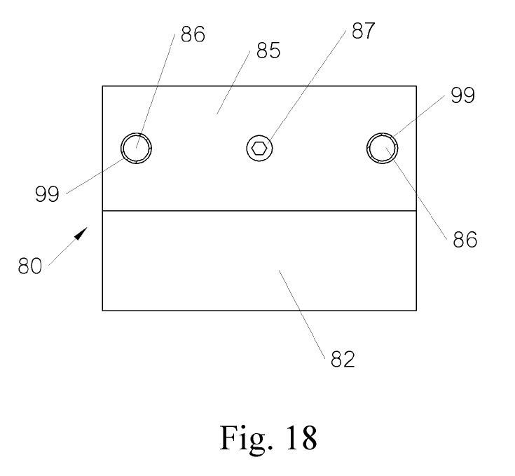

FIG. 17 is a front view of machine vice 80 showing base plate 82, back jaw 81, movable jaw 83, fixed jaw 85 and guide pin 86. FIG. 18 is a side view of machine vice 80 showing base plate 82, driving means 87 and guide pins 86. Guide pins 86 are slidably connected to fixed jaw 85 using reformable bearing material 99.

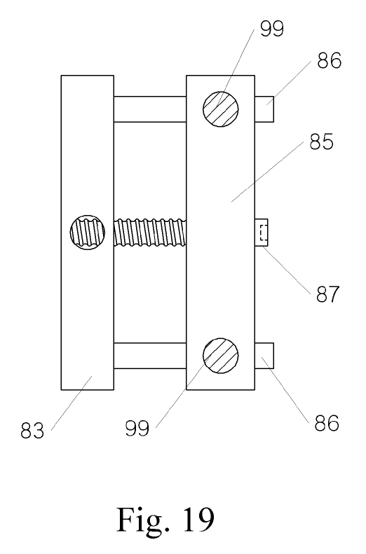

FIG. 19 is a bottom view of fixed jaw 85 and movable jaw 83. Caps have been removed so that bearing material 99, which has been formed in place around guide pins 86, can be seen. Driving means 87 is also shown extending into movable jaw 83. In this embodiment the present invention is used to precisely locate guide pins 86 so that they guide movable jaw 83 with respect to fixed jaw 85.

In the embodiment shown in FIGS. 16-19 the present invention is used to create an inexpensive machine tool vice which is very rigid and that precisely locates the movable vice jaw with respect to the fixed vice jaw without the need for precisely machined surfaces.

A key feature of the present invention is the ability to create precisely guided sliding surfaces without the need for highly accurate machining operations using a reformable bearing material. An additional key feature of the present invention is the ability to reform the bearing material in place to recover from wear without the need to disassemble machine components and to thereby recover accurately guided sliding motion.

Another important feature of the present invention is that no removable tooling is required for the formation of sliding joints. Hardenable bearing material can be extruded in place using the geometry of the opposing sliding surfaces to constrain the bearing material.

Yet another important feature of the present invention is that it enables a method of machine tool construction utilizing common elements and machining processes to create joints which accurately guide and drive machine members which greatly reduces the cost of a machine tool. This is especially advantageous for low-cost machine tools intended for the education or maker markets.

Yet another important feature of the present invention is that the cavities into which the reformable bearing material flows can be used to hold the reformable bearing material in place in such a way that no adhesive, additive or fixturing is typically required, although such adhesives, additives or fixturing could be used if desired.

The advantages of the invention should now be readily apparent to those skilled in the art without the necessity for a more detailed description of the elements. With respect to the above description it is to be understood that the optimal dimensional relationships for the parts of the invention, to include variations in size, materials, shape, form, function and manner of operation, assembly, and use, are deemed readily apparent and obvious to one skilled in the art. All equivalent relationships to those illustrated in the drawings and described in the specification are intended to be encompassed by the present invention.

Therefore, the foregoing is to be considered as only illustrative of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of forming precise bearing surfaces for bearing components of a slide assembly comprising the steps of:
forming a pocket in a first member having at least one opening capable of receiving a second member, said pocket having sufficient clearance around said second member such that when said second member is inserted into said pocket a cavity is formed between said pocket in said first member and said second member, said cavity having space to accommodate the introduction of a hardenable bearing fluid;
forming a second member with a shape that, when supported by said hardenable bearing fluid in its hardened state, will cooperate with said hardenable bearing fluid in its hardened state to produce a sliding joint that constrains at least 3 degrees of freedom while allowing guided translation along or rotation about at least one degree of freedom;
inserting said second member into said pocket in said first member;
introducing a hardenable bearing fluid into said cavity between said pocket in said first member and said second member; and
causing said hardenable bearing fluid to harden.

2. A method according to claim 1 wherein said second member is a rod, a round threaded rod, a round rod, a round rod with a radial grove, a round rod with an axial grove, a rod with a square cross-section, a rod with a rectanglular cross-section, a rod with a “D” shape cross-section, a rod with a key seat, or a rod with a cross-section in the shape of a regular polygon.

3. A method according to claim 1 wherein said first member or said second member or both said first member and said second member include at least one feature to locate said second member in a desired position relative to said first member prior to the introduction of said hardenable bearing fluid.

4. A method according to claim 3 wherein said at least one feature to locate said second member in a desired position relative to said first member includes a shoulder formed on said first member or said second member or both said first member and said second member.

5. A method according to claim 1 wherein said pocket in said first member includes at least one hole through said first member of sufficient size to allow said second member to pass through said hole in said first member.

6. A method according to claim 1 wherein said pocket in said first member includes at least one passage to enable the introduction of said hardenable bearing fluid.

7. A method according to claim 6 wherein said at least one passage includes at least one threaded hole to enable the introduction of said hardenable bearing fluid under pressure, said pressure being created by a threaded plug being rotated into said threaded hole, by air pressure, by hydraulic pressure, by gravity or by an electrical solenoid.

8. A method according to claim 6 wherein said at least one passage includes means for connecting said at least one passage to a source of pressurized fluid to enable the introduction of said hardenable bearing fluid under pressure from said source of pressurized fluid.

9. A method according to claim 1 wherein said method of introducing said hardenable bearing fluid into said cavity includes heating of said hardenable bearing fluid above its melting temperature and said method of causing said hardenable bearing fluid to harden includes cooling of said hardenable bearing fluid below its solidification temperature.

10. A method according to claim 9 wherein said method of introducing said bearing fluid into said cavity includes heating of said first member, said second member, and said hardenable bearing fluid above the melting temperature of said hardenable bearing fluid and said method of causing said hardenable bearing fluid to harden includes cooling of said first member, said second member, and said hardenable bearing fluid below the solidification temperature of said hardenable bearing fluid.

11. A method according to claim 1 wherein said hardenable bearing fluid is a plastic.

12. A method according to claim 11 wherein said hardenable bearing fluid is polyethylene.

13. A method according to claim 12 wherein said hardenable bearing fluid is ultrahigh molecular weight polyethylene.

14. A method according to claim 1 wherein said first member and said second member each have mating dovetail way surfaces and wherein said second member, when supported by said hardenable bearing fluid in its hardened state, will cooperate with said hardenable bearing fluid in its hardened state to produce a sliding joint that constrains at least 5 degrees of freedom while allowing guided motion along at least one degree of freedom.

15. A method according to claim 1 wherein said first member and said second member each have mating flat or rectangular guide surfaces.

16. A method according to claim 1 wherein said method for introducing a hardenable bearing fluid into said cavity can be repeatedly accomplished without disassembly of any of said slide assembly components by heating of said first member, said second member, and said hardenable bearing fluid above the melting temperature of said hardenable bearing fluid, re-extruding said hardenable bearing material, and cooling of said first member, said second member, and said hardenable bearing fluid below the solidification temperature of said hardenable bearing fluid.

17. A method according to claim 16 wherein said re-extruding of said hardenable bearing material includes a preloaded spring configured to urge a surface against said hardenable bearing fluid.

18. A method according to claim 16 wherein said re-extruding of said hardenable bearing material includes means for connecting said at least one passage to a source of pressurized fluid to re-extrude said hardenable bearing fluid into said cavity under pressure from said source of pressurized fluid.

19. A method according to claim 16 wherein said heating of said first member, said second member, and said hardenable bearing fluid above the melting temperature of said hardenable bearing fluid includes an electrical heater.

20. A slide assembly with precision bearing surfaces manufactured by the method of claim 1.
